(19) United States
(12) Patent Application Publication
(10) Pub. No.: US 2026/0119391 A1
(43) Pub. Date: Apr. 30, 2026

(54) METHOD AND SYSTEM FOR DYNAMICALLY RECONFIGURING SIZE OF SLC BUFFER REGION OF FLASH MEMORY DEVICE

(71) Applicant: Samsung Electronics Co., Ltd., Suwon-si (KR)

(72) Inventors: Sumeet PAUL, Bengaluru (IN); Akhilesh Kumar JAISWAL, Bengaluru (IN); Gunmeet Singh CHADHA, Bengaluru (IN); Puneet KUKREJA, Bengaluru (IN); Shankar ATHANIKAR, Bengaluru (IN)

(73) Assignee: Samsung Electronics Co., Ltd., Suwon-si (KR)

(21) Appl. No.: 19/010,359

(22) Filed: Jan. 6, 2025

(30) Foreign Application Priority Data
Oct. 29, 2024 (IN) 202411082961

(51) Int. Cl. G06F 12/02

(52) U.S. Cl. CPC G06F 12/0246; G06F 2212/7202

(57) ABSTRACT

The present disclosure relates to field of storage devices that provides method and system for dynamically reconfiguring size of SLC buffer region of flash memory device. The method is performed by buffer reconfiguration system by receiving request from host to determine maximum reconfigurable size of SLC buffer region, determining feasibility of reconfiguring current size of SLC buffer region, computing maximum reconfigurable size of SLC buffer region based on parameters, sending response indicating feasibility of reconfiguring current size and maximum reconfigurable size to host, receiving command indicating reconfigure current size to a new size of the SLC buffer region from host, and allocating plurality of free blocks from the MLC region to SLC buffer region to reconfigure current size of SLC buffer region. The present disclosure provides flexibility to dynamically reconfigure the SLC buffer region.

### CROSS-REFERENCE TO RELATED APPLICATION

This U.S. non-provisional application claims the benefit of priority under 35 U.S.C. 119 from Indian Patent Application number 202411082961, filed on Oct. 29, 2024 in the Indian Intellectual Property Office, the entire contents of which are herein incorporated by reference.

### TECHNICAL FIELD

The present disclosure relates to storage devices. Particularly, the present disclosure relates to a method and system for dynamically reconfiguring size of SLC buffer region of flash memory device.

### BACKGROUND

Single Level Cell (SLC) buffer plays an important role in Multi-Level Cell (MLC) based NAND flash memory devices. For instance, MLC may include Double Level Cell (DCL)/Triple-Level Cell (TLC)/Quad-Level Cell (QLC) based NAND flash memory devices. The NAND flash device may include Universal Flash Storage (UFS), Embedded Multi-Media Card (eMMC) and Solid-State Drive (SSD), as SLC buffer can deliver higher performance in different programming schemes. In other words, to resolve or improve slow READ/WRITE performance of MLC based NAND flash memory devices, Flash Translation Layer (FTL) uses SLC buffer region. Size of the SLC buffer region may depend on the capacity of the flash memory device. As long as the SLC buffer region within the flash memory device remains underutilized, the flash memory device's READ/WRITE performance may closely match that of SLC buffer region with the flash memory device. However, currently, a host can configure SLC buffer region size only once. After configuring, the host sets a partition complete bit in order to perform reformat and allocate SLC buffer blocks as shown in FIG. 1. Referring to FIG. 1, the host system may send a command to the flash memory device to determine the maximum size allowable for the SLC buffer. Upon determination, the host determines the desired SLC buffer region size and sends a corresponding command to the flash memory device. If the desired SLC buffer region size exceeds the device's maximum limit, the process may be ended. However, if the requested size is permissible, the system may check whether repartitioning of the device is permitted. If repartition is not allowed, the process may be terminated without making any changes to the device's configuration. On the contrary, if repartition of the device is permitted, the host system may proceed to configure the SLC buffer size accordingly and may set the partition configure bit, finalizing the configuration process.

As illustrated in FIG. 1, reformatting is desired in the existing process as repartitioning is beneficial to adjust the partition structure of the flash memory device. However, as reformatting may be performed, host data will be lost and SLC buffer size cannot be configured at run time. There could be many situations where the host would like to reconfigure SLC buffer size without losing any user data.

Furthermore, the SLC buffer region may not be appropriately sized based on use case. As an example, consider that the host has configured SLC buffer size of 30 GB. However, as per actual usage, SLC buffer size of 30 GB may not be required or desired. Therefore, having a large SLC buffer size of 30 GB will impact performance due to migration, early garbage collection and can finally impact the lifetime of device. Therefore, selecting the SLC buffer size to be used must be done carefully based on actual use case e.g., Data Pattern, chunk Size, etc.

Hence, there is a desire for a system that enables the dynamic reconfiguration of SLC buffer size, while safeguarding user data integrity in the flash memory device and addressing the challenges inherent in such reconfigurations.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein according to some example embodiments is a method of dynamically reconfiguring size of a Single Level Cell (SLC) buffer region of a flash memory device, the method including receiving, by a buffer reconfiguration system associated with a flash memory device, a request from a host to determine a maximum reconfigurable size of a SLC buffer region of the flash memory device. Further, the method includes determining, by the buffer reconfiguration system, a feasibility of reconfiguring a current size of the SLC buffer region based on one or more parameters related to the flash memory device, in response to the request received from the host. Thereafter, the method includes computing, by the buffer reconfiguration system, the maximum reconfigurable size of the SLC buffer region based on the one or more parameters and remaining free blocks in a Multi-Level Cell (MLC) region in the flash memory device, in response to the reconfiguration of the current size of the SLC buffer region being determined to be feasible. Furthermore, the method includes sending, by the buffer reconfiguration system, a response including an indication of the feasibility of reconfiguring the current size of the SLC buffer region and the maximum reconfigurable size of the SLC buffer region to the host. Further, the method includes receiving, from the host, by the buffer reconfiguration system, a command including an indication to reconfigure the current size to a new size of the SLC buffer region determined based on the maximum reconfigurable size of the SLC buffer region. Finally, the method includes allocating, by the buffer reconfiguration system, a plurality of free blocks from the MLC region to the SLC buffer region to reconfigure the current size of the SLC buffer region to the new size, in response to the command.

Disclosed herein according to some example embodiments is a buffer reconfiguration system for dynamically reconfiguring size of a Single Level Cell (SLC) buffer region of a flash memory device, the system including a processor and a memory, communicatively coupled to the processor, wherein the memory is configured to store instructions, which, on execution, causes the processor to receive a request from a host to determine a maximum reconfigurable size of a SLC buffer region of the flash memory device. Further, the processor determines the feasibility of reconfiguring the current size of the SLC buffer region based on one or more parameters related to the flash memory device, in response to the request received from the host. The processor thereafter computes the maximum reconfigurable size of the SLC buffer region based on the one or more parameters and remaining free blocks in a Multi-Level Cell (MLC) region in the flash memory device, in response to the reconfiguration of the current size of the SLC buffer region being determined to be feasible. Further, the processor sends a response including an indication of the feasibility of reconfiguring the current size of the SLC buffer region and the maximum reconfigurable size of the SLC buffer region to the host. Furthermore, the processor receives, from the host, a command including an indication to reconfigure the current size to a new size of the SLC buffer region determined based on the maximum reconfigurable size of the SLC buffer region. Finally, the processor allocates a plurality of free blocks from the MLC region to the SLC buffer region to reconfigure the current size of the SLC buffer region to the new size, in response to the command.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate some example embodiments and, together with the description, explain the disclosed principles. In the figures, the left-most digit(s) of a reference number identifies the figure in which the reference number first appears. The same numbers are used throughout the figures to reference like features and components. Some embodiments of the system and/or methods in accordance with some example embodiments of the present subject matter are now described, by way of example only, and regarding the accompanying figures, in which:

FIG. 1 [Prior art] shows a flowchart illustrating an existing scenario of reconfiguring size of SLC buffer region of flash memory device;

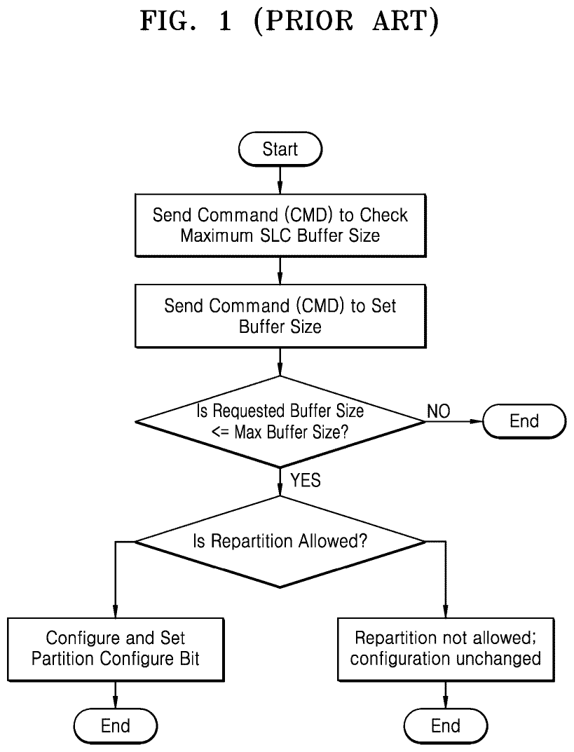

FIG. 2 shows an example architecture for dynamically reconfiguring size of SLC buffer region of flash memory device, in accordance with some example embodiments of the present disclosure;

FIG. 3A shows a detailed block diagram of a buffer reconfiguration system for dynamically reconfiguring size of SLC buffer region of flash memory device, in accordance with some example embodiments of the present disclosure;

FIG. 3B shows a new register (E.g.: EXT_CSD register) of a buffer reconfiguration system for dynamically reconfiguring size of SLC buffer region of flash memory device, in accordance with some example embodiments of the present disclosure;

FIG. 3C shows an indication of maximum reconfigurable buffer size through a new register (E.g.: EXT_CSD register) of a buffer reconfiguration system, in accordance with some example embodiments of the present disclosure;

FIG. 4 shows an example flowchart illustrating a method of dynamically reconfiguring the size of SLC buffer region of flash memory device, in accordance with some example embodiments of the present disclosure; and

FIG. 5 illustrates a general computer system architecture, in accordance with some example embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “example” is used herein to mean “serving as an example, instance, or illustration.” Any embodiment or implementation of the present subject matter described herein as “example” is not necessarily to be construed as preferred or advantageous over some other example embodiments.

While the disclosure is susceptible to various modifications and alternative forms, specific example embodiment thereof has been shown by way of example in the drawings and will be described in detail below. It should be understood, however, that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

As discussed in the background section, SLC Buffering is commonly used in MLC based NAND flash products to achieve better performance and migrate SLC data during idle time. However, a host can configure SLC buffer region size within maximum allocated limit only once, and cannot be modified dynamically, to increase or decrease SLC buffer size on need basis. Hence, there is a need to provide a method and system for the host to reconfigure SLC buffer size dynamically, without any loss of data and runtime. In the present disclosure, a buffer reconfiguration system associated with the flash memory device dynamically reconfigures the size of a SLC buffer region of a flash memory device. The buffer reconfiguration system may receive a request from a host to determine the maximum reconfigurable size of a SLC buffer region of the flash memory device. Upon receiving the request, the system may determine the feasibility of reconfiguring the current size of the SLC buffer region based on parameters e.g., Valid Page Count (VPC), Erase Count (EC), Bad Block ratio, current SLC buffer size etc. related to the flash memory device. When the reconfiguration of the current size of the SLC buffer region is determined to be feasible, the system may compute the maximum reconfigurable size of the SLC buffer region based on the said parameters and remaining free blocks in a Multi-Level Cell (MLC) region in the flash memory device. Thereafter, the system may send a response comprising an indication of the feasibility of reconfiguring the current size of the SLC buffer region and the maximum reconfigurable size of the SLC buffer region to the host. On the command of the host for reconfiguring the current size to a new size of the SLC buffer region, the system may perform migration, purge or sanitization, and termination of the SLC. Thereafter, the system may allocate a plurality of free blocks from the MLC region to the SLC buffer region to reconfigure the current size of the SLC buffer region to the new size. Through the present disclosure, the SLC buffer region can be re-configured dynamically without data loss, provides flexibility to increase or decrease new SLC buffer region, and reconfigure the SLC buffer region multiple times.

In the following detailed description of some example embodiments of the disclosure, reference is made to the accompanying drawings that form a part hereof, and in which are shown by way of illustration specific example embodiments in which the disclosure may be practiced. These example embodiments are described in sufficient detail to enable those skilled in the art to practice the disclosure, and it is to be understood that some other example embodiments may be utilized and that changes may be made without departing from the scope of the present disclosure. The following description is, therefore, not to be taken in a limiting sense.

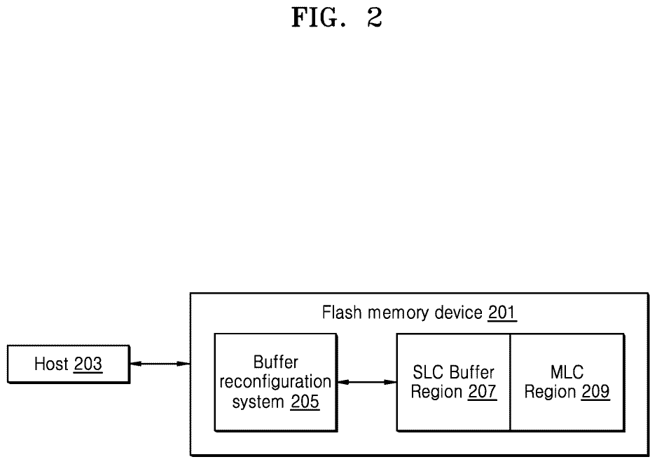

FIG. 2 shows an example architecture 200 for dynamically reconfiguring size of SLC buffer region 207 of flash memory device 201, in accordance with some example embodiments of the present disclosure.

Exemplary architecture 200 comprises a flash memory device 201 and a host 203. The Flash memory device 201 may comprise different level cells. Said level cells may comprise a Single-Level Cell (SLC) buffer region 207 and Multi-Level Cell (MLC) region 209. MLC region 209 may include, but not limited to, Double-Level Cell (DLC) region, Triple-Level Cell (TLC) region, Quad-Level Cell (QLC) region and the like. A buffer reconfiguration system 205 may be configured within the flash memory device 201 as shown in FIG. 2. In some example embodiments, the flash memory device 201 may include, but not limited to, NAND based flash memory device 201, Solid State Drive (SSD), embedded Multi-Media Card (eMMC) and Universal Flash Storage (UFS). Host 203 is communicatively connected with the flash memory device 201. In some example embodiments, the host 203 may include, but not limited to, laptop computers, personal computers, digital recording and playback devices, mobile telephones, Personal Digital Assistants (PDAs), memory card readers, and interface hubs, among other host systems.

In the present disclosure, the host 203 may communicate with the buffer reconfiguration system 205 of the flash memory device 201 as shown in FIG. 2. The host 203 may be used to control the process of dynamic reconfiguration of the SLC buffer of the flash memory device 201. The host 203 may be configured to send the request to the buffer reconfiguration system 205 to determine a maximum reconfigurable size of a SLC buffer region 207 of the flash memory device 201. In some example embodiments, the host 203 may receive the response comprising an indication of the feasibility of reconfiguring the current size of the SLC buffer region 207. The host 203 may further receive the maximum reconfigurable size of the SLC buffer region 207 from the buffer reconfiguration system 205 if it is feasible to reconfigure the current size of the SLC buffer. In some example embodiments, host 203 may send a command comprising indication to reconfigure the current size to a new size of the SLC buffer region 207 determined based on the maximum reconfigurable size of the SLC buffer region 207. In some example embodiments, the host 203 may also be configured to control the data processing (or access) operations (e.g., READ/WRITE operations) of a flash memory device 201.

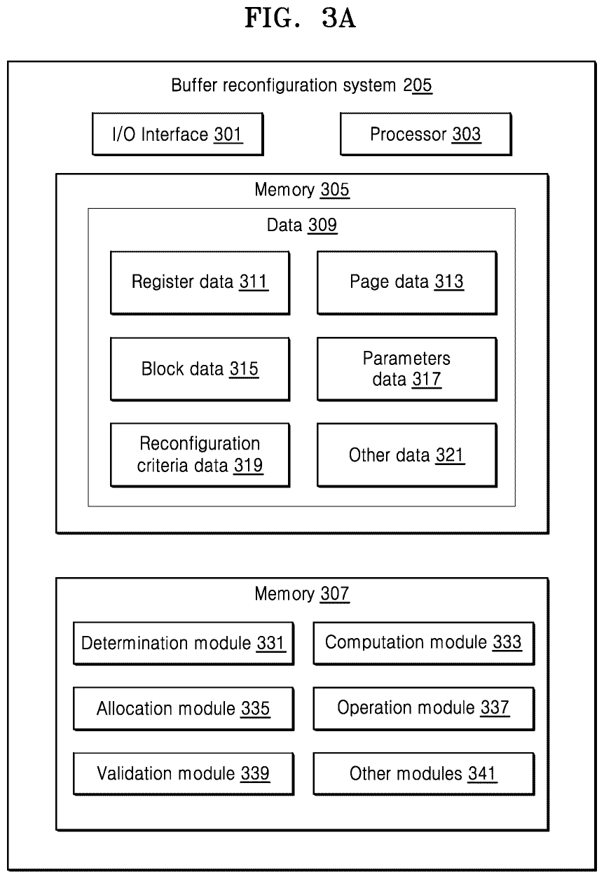

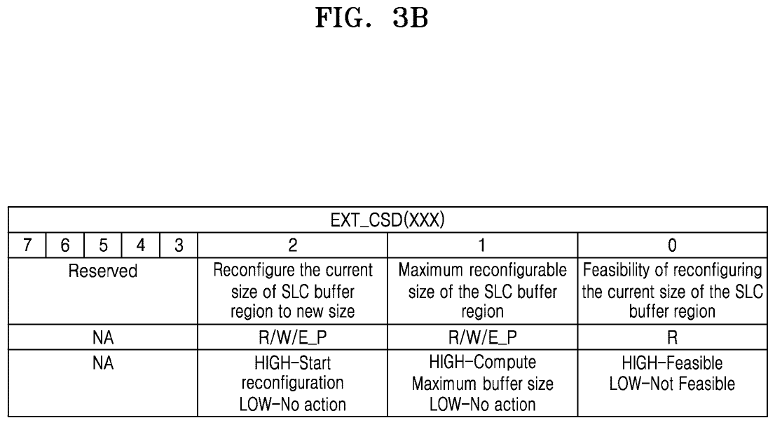

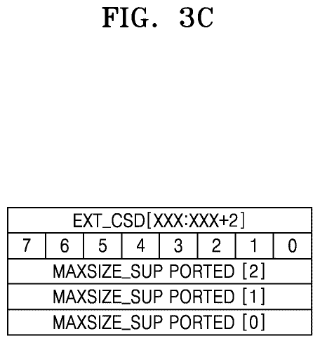

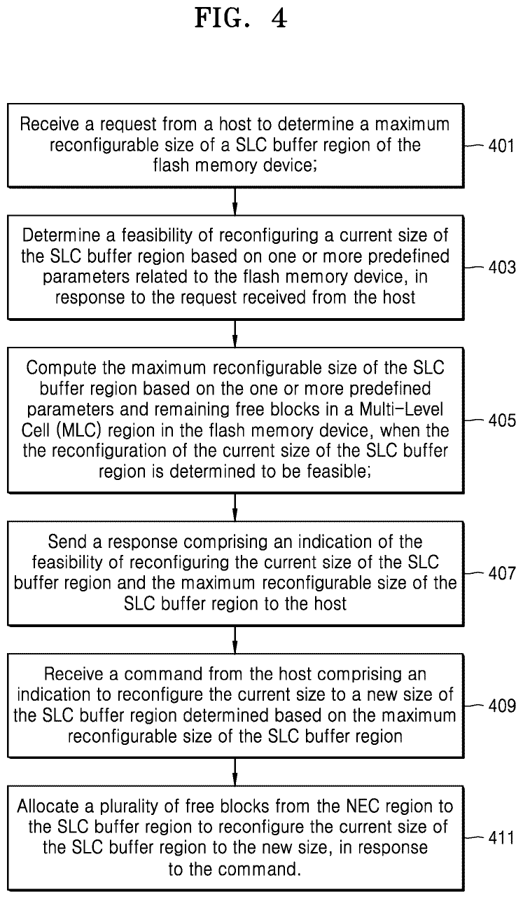

In some example embodiments, the buffer reconfiguration system 205 may be configured to receive a request from the host 203 to determine the maximum reconfigurable size of the SLC buffer region 207 of the flash memory device 201. In some example embodiments, the buffer reconfiguration system 205 may determine the feasibility of reconfiguring a current size of the SLC buffer region 207 based on one or more predefined (or, alternatively, desired, determined, or selected) parameters related to the flash memory device 201 such as Valid Page Count (VPC), Erase Count (EC), Bad Block ratio, current SLC buffer size etc. Thereafter, the buffer reconfiguration system 205 may compute the maximum reconfigurable size of the SLC buffer region 207 based on the one or more predefined (or, alternatively, desired, determined, or selected) parameters and remaining free blocks in MLC region in the flash memory device 201, when the reconfiguration of the current size of the SLC buffer region 207 is determined to be feasible. In some example embodiments, based on the computation, the buffer reconfiguration system 205 may send a response comprising an indication of the feasibility of reconfiguring the current size of the SLC buffer region 207 and the maximum reconfigurable size of the SLC buffer region 207 to the host 203. The buffer reconfiguration system 205 may subsequently receive a command comprising an indication to reconfigure the current size to a new size of the SLC buffer region 207 determined based on the maximum reconfigurable size of the SLC buffer region 207. In some example embodiments, the buffer reconfiguration system 205 may allocate the free blocks from the MLC region 209 to the SLC buffer region 207 to reconfigure the current size of the SLC buffer region 207 to the new size, in response to the command. The method is explained in more detail under FIG. 3A, FIG. 3B and FIG. 4 in the present disclosure.

FIG. 3A shows a detailed block diagram of the buffer reconfiguration system 205 for dynamically reconfiguring size of SLC buffer region 207 of flash memory device 201, in accordance with some example embodiments of the present disclosure.

In some example embodiments, the buffer reconfiguration system 205 may include an I/O Interface 301, a processor 303 and a memory 305. In some example embodiments, the memory 305 may be communicatively coupled to the processor 303. The processor 303 may be configured to perform one or more functions of the buffer reconfiguration system 205, using data 309 and the one or more modules 307 of the buffer reconfiguration system 205. In some example embodiments, memory 305 may store data 309.

In some example embodiments, the data 309 stored in the memory 305 may include, without limitation, register data 311, page data 313, block data 315, parameter data 317, reconfiguration criteria data 319 and other data 321. In some example embodiments, data 309 may be stored within memory 305 in the form of various data structures. Additionally, data 309 may be organized using data models, such as relational or hierarchical data models. The other data 321 may include various temporary data and files generated by the one or more modules 307.

In some example embodiments, the register data 311 may store one or more fields related to reconfiguration of buffer region and corresponding flag values in a new register. An example new register EXT_CSD is illustrated in FIG. 3B. The one or more fields may comprise a field indicating feasibility of reconfiguring the current size of the SLC buffer region 207 as shown under bit 0 of the example register in FIG. 3B, a field indicating maximum reconfigurable size of the SLC buffer region 207 as shown under bit 1 of the example register in FIG. 3B, and a field indicating reconfiguration of the current size of SLC buffer region 207 to a new size as shown under bit 2 of the example register in FIG. 3B. Further, flag values may indicate flag enabled status or flag disabled status based on values such as “HIGH/LOW” or “I/O” and the like. As an example, EXT_CSD register may be used to control operation related to reconfiguration of SLC buffer region 207 of flash memory device 201, and bits 3-7 may be reserved for other purposes. In some example embodiments, the buffer reconfiguration system 205 may set the flag value to “HIGH” for the field of feasibility of reconfiguring the current size of the SLC buffer region 207, if it is feasible to reconfigure a current size of the SLC buffer region 207 else, the buffer reconfiguration system 205 may set the flag value to “LOW”. In some example embodiments, consider that, it is determined that it is feasible to reconfigure the current size of the SLC buffer region 207, the buffer reconfiguration system 205 may set the flag value to “HIGH” for field of maximum reconfigurable size of the SLC buffer region 207 and activate the computation of maximum reconfigurable size of the SLC buffer region 207 else, the buffer reconfiguration system may set value for field of maximum reconfigurable size of the SLC buffer region 207 to “LOW” as the flag value of the field of feasibility of reconfiguring the current size indicates value to “LOW”. In some example embodiments, consider that the field maximum reconfigurable size of the SLC buffer region 207 of register indicates the flag value to “HIGH”, and the command from the host indicates to reconfigure the size of SLC buffer region 207, the buffer reconfiguration system 205 may set the flag value to “HIGH” for the field of reconfiguration of the current size of SLC buffer region 207 to a new size else, the flag value may be set to “LOW”. Accordingly, the EXT_CSD register may be used to configure the SLC buffer region 207 of flash memory device 201. In some example embodiments, along with indication via a flag value to reconfigure the size of the SLC buffer region 207, the EXT_CSD register may also indicate the maximum reconfigurable size of the SLC buffer region 207 as shown in the FIG. 3C.

In some example embodiments, the page data 313 may store the data related to pages within the blocks of the flash memory device 201. The page data 313 may store data related to, but not limited to total page count in each block, number of Valid Page Count (VPC), statistics of VPC, number of invalid page count, historical VPC data, memory usage statistics, and configuration settings related to page count management. The VPC refers to the number of valid data pages which store reliable dataset that adheres to predefined standards and formats.

In some example embodiments, the block data 315 may store the data related to the valid data blocks and invalid data blocks of the flash memory device 201. Said valid data block refers to a physical sector or region on a flash memory device 201 that contains accurate, error-free information. Said valid data block represents a reliable dataset that adheres to predefined standards and formats. An invalid data block represents a section of flash memory device 201 that contains corrupted or erroneous information. Invalid data deviates from the expected data format or content and may be considered unreliable for use by software applications or system processes. The block data 315 may store total number of valid data blocks and invalid data blocks, distribution of valid data blocks and invalid data blocks within the flash memory device 201, usage patterns, type of errors or corruption in valid data blocks and the like.

In some example embodiments, the parameter data 317 may store data related to bad blocks, Erase Count (EC), and total lifetime of the flash memory device 201.

The bad block may refer to a physical sector or region on a flash memory device 201, that is defective or damaged and cannot reliably store data. Bad blocks can be caused by factors that may include, but not limited to, manufacturing defects, physical damage, wear and tear over time, or data corruption. The parameter data 317 may store the data which may include, but not limited to, total number of the bad blocks with the flash memory device 201, physical address or location of the bad blocks in the flash memory device 201, severity level of the bad blocks, root cause of the bad blocks and the like.

The EC may refer to number of times a specific memory block or sector within a flash memory device 201 has been subjected to an erase operation. The parameter data 317 may store the data which may include, but not limited to, information of the total number of erase cycles performed on the flash memory device 201, historical trends or patterns of erase count activity over time and the like. Said data may also indicate the overall usage and lifespan of the flash memory device 201.

The lifetime of the flash memory may refer to the duration over which the device is expected to reliably store and retrieve data under normal operating conditions. The parameter data 317 may store the data which may include, but not limited to, power cycles, READ/WRITE operations, data transfer rates, device's age, usage duration, maintenance history, health, and performance of individual components within the flash memory device 201 and the like.

In some example embodiments, the reconfiguration criteria data 319 may store predefined criteria to determine the feasibility of reconfiguring the current size of the SLC buffer region 207. Said one or more predefined criteria are based on the parameters stored by the page data 313 and the parameter data 317. The one or more predefined parameters may comprise, but not limited to, a VPC of the flash memory device 201, an EC of the flash memory device 201, a bad block ratio of the flash memory device 201 and the current size of the SLC buffer region 207. The one or more predefined parameters should comply with the predefined criteria to reconfigure the current size of the SLC buffer region 207. The predefined criteria may include, but not limited to, a first criterion, a second criterion, a third criterion and a fourth criterion. The first criterion may indicate that the percentage of the VPC should be less than the first predefined threshold percentage of the total Page Count (PC). As an example, the first criterion may be that VPC should be less than 90% of total PC, where the first predefined threshold percentage of VPC may be considered as 90%. The second criterion may indicate the EC to be less than the second predefined threshold percentage of the total lifetime of flash memory. As an example, the second criterion may be that EC should be equal to or less than 70% of the total lifetime of flash memory, where the second predefined threshold percentage of the EC may be considered as 70%. The third criterion may indicate the bad block ratio to be less than the predefined threshold percentage of the total lifetime of flash memory 201. As an example, the third criterion may be that a bad block ratio should be less than 80% of the total lifetime of a flash memory where the third predefined threshold percentage of the bad block ratio may be considered as 80%. The fourth criterion may indicate the current size of the SLC buffer region 207 to be less than the maximum reconfigurable size of the SLC buffer region 207. As an example, the fourth criterion may be that the current size of the SLC buffer region 207 should be less than 14 GB when the maximum reconfigurable size of the SLC buffer region 207 is 14 GB. However, the inventive concepts are not limited thereto, and other values may be used, e.g., 4 GB, 8 GB, 10 GB, 16 GB, etc.) In some example embodiments, the predefined criteria and/or the predefined thresholds may be, alternatively, desired criteria/thresholds, determined criteria/thresholds, or selected criteria/thresholds.

In some example embodiments, data 309 may be processed by one or more modules 307 of the buffer reconfiguration system 205. In some example embodiments, the one or more modules 307 may be communicatively coupled to processor 303 for performing one or more functions of the buffer reconfiguration system 205. In some example embodiments, one or more modules 307 may include, without limiting to, determination module 331, computation module 333, allocation module 335, operation module 337, validation module 339 and other modules 341.

As used herein, the term module may refer to an Application Specific Integrated Circuit (ASIC), an electronic circuit, a hardware processor (shared, dedicated, or group) and memory that executes one or more software or firmware programs, a combinational logic circuit, and/or other suitable components that provide the described functionality. In some example embodiments, each of the one or more modules 307 may be configured as stand-alone hardware computing units. In some example embodiments, the other modules 341 may be used to perform various miscellaneous functionalities on the buffer reconfiguration system 205. It will be appreciated that such one or more modules 307 may be represented as a single module or a combination of different modules.

In some example embodiments, the determination module 331 may determine the feasibility of reconfiguring the current size of the SLC buffer region 207 based on one or more predefined parameters related to the flash memory device 201. Said determination module 331 determines the feasibility of reconfiguring the current size of the SLC buffer region 207 when the request is received from a host 203. As an example, the feasibility of reconfiguring the current size of the SLC buffer region 207 is determined based on one or more predefined parameters and the predefined criteria. One or more predefined parameters may include, but not limited to VPC of the flash memory device 201, EC of the flash memory device 201, bad block ratio of the flash memory device 201 and the current size of the SLC buffer region 207. In some example embodiments, the register data 311 may indicate the flag value corresponding to the field of feasibility of reconfiguring a current size of the SLC buffer region 207 in a new register as shown under bit 0 of the example register in FIG. 3B. In some example embodiments, it is considered that, one or more predefined parameters complied within the predefined criteria, the buffer reconfiguration system 205 may set the flag value to “HIGH” for the field of feasibility of reconfiguring the current size of the SLC buffer region 207 in a new register as shown under bit 0 of the example register in FIG. 3B else, the buffer reconfiguration system 205 may set the flag value to “LOW”. In some example embodiments, the predefined parameters may be, alternatively, desired parameters, determined parameters, or selected parameters.

In some example embodiments, it is determined that it is feasible to reconfigure the current size of the SLC buffer region 207, the buffer reconfiguration system 205 may set the flag value to “HIGH” for field of maximum reconfigurable size of the SLC buffer region 207 in a new register as shown under bit 1 of the example register in FIG. 3B. and activate the computation module 333 to compute maximum reconfigurable size of the SLC buffer region 207. Otherwise, the buffer reconfiguration system may set value for field of maximum reconfigurable size of the SLC buffer region 207 to “LOW” as the flag value of the field of feasibility of reconfiguring the current size indicates value to “LOW”.

In some example embodiments, the computation module 333 may compute the maximum reconfigurable size of the SLC buffer region 207 based on the one or more predefined parameters, intermediate buffer sector indicating the size of the MLC as a safeguard, type of the MLC, and remaining free blocks in the flash memory device 201. Said computation module 333 may compute the maximum reconfigurable size of the SLC buffer region 207 when the reconfiguration of the current size of the SLC buffer region 207 is determined to be feasible.

The maximum reconfigurable size of the SLC buffer region 207 may be computed by the computation module 333 using the following expression:

$$= \frac{Remaining free blocks - Intermediate buffer sector}{Type of the MLC} \qquad equation ( 1 )$$

In some example embodiments, the allocation module 335 may allocate a plurality of free blocks from the MLC region 209 to the SLC buffer region 207 to reconfigure the current size of the SLC buffer region 207 to the new size when the command is received from the host 203. In some example embodiments, the register data 311 may indicate the flag value corresponding to field of reconfigure the current size of the SLC buffer region 207 to a new size. As an example, consider that, the field of the maximum reconfigurable size of the SLC buffer region 207 of the EXT_CSD register sets the flag value to “HIGH”, and a command from the host 203 indicates to reconfigure the size of SLC buffer region 207 to a new size, the buffer reconfiguration system 205 may set the flag value to “HIGH” for the field of reconfigure the current size of SLC buffer region 207 in a new register as shown under bit 2 of the example register in FIG. 3B. and activate the allocation module 335 to reconfigure the current size of the SLC buffer region 207 to a new size else, the buffer reconfiguration system 205 may set the flag value to “LOW”.

In some example embodiments, the operation module 337 may perform various functions prior to allocating the plurality of free blocks to the SLC buffer region 207 to reconfigure the current size of the SLC buffer region 207 to the new size. The operation module 337 may be configured to perform various functions which may comprise, but not limited to, migration process, sanitization or purge process, and termination process. In the migration process, the operation module 337 may migrate the pre-stored valid data from one or more blocks of the SLC buffer region 207 to one or more blocks of a Multi-Level Cell (MLC) region 209 of the flash memory device 201, if there is a requirement (or alternatively, desire, command, or instruction) for migrating the pre-stored valid data. In the sanitization or purge process, the operation module 337 may sanitize or purge the pre-stored invalid data from one or more blocks of the SLC buffer region 207, when presence of invalid data is detected. In the termination process, the operation module 337 may terminate one or more blocks of the SLC buffer region 207 which are in operational condition. It is to be construed that the operation module 337 is not restricted to performing only the specified functions. Additionally, it should be noted that individual functions may be conducted by other modules 341, and these functions are not exclusively limited to the operation module 337.

In some example embodiments, the validation module 339 may validate the new size of the SLC buffer region 207 is less than or equal to the maximum reconfigurable size of the SLC buffer region 207 after allocating the plurality of free blocks by the allocation module 335 of the buffer reconfiguration system 205.

Consider an example scenario, the buffer reconfiguration system 205 determines the maximum reconfigurable SLC buffer region 207 for 64 GB of TLC type NAND based flash memory device 201. The parameters associated with the NAND based flash memory device 201 are shown in the following Table.

| Sr. No. | Parameters | Quantity | |
|---|---|---|---|
| 1 | Type of the cell | Triple Level | |
| | | Cell (TLC) -3 | |
| 2 | Total size of the TLC type NAND | 64 | GB |
| | based flash memory device | | |
| 3 | Actual size of the TLC type NAND | ~59 | GB |
| | based flash memory device | | |
| 4 | Intermediate buffer sector of TLC | 5 | GB |
| 5 | VPC of the flash memory device | 60% | |
| 6 | Remaining free space based on VPC | 40% | |
| | in Percentage | | |
| 7 | Remaining free blocks based on VPC | 23.6 | GB |
| 8 | Current size of the SLC buffer region | 2 | GB |

| | | |
|---|---|---|
| 9 | Erase Count (EC) | <70% of total device |
| | | lifetime |
| 10 | Bad block ratio | <80% of total device |
| | | lifetime |

On receiving a request from host 203, the buffer reconfiguration system 205 determines the feasibility of reconfiguring the current size of the SLC buffer region 207 based on the one or more predefined parameters and criteria related to the flash memory device 201.

As shown in above table, the VPC is less than the 90% of total Page Count (PC) of block of memory, the EC is less than the 70% of the total lifetime, the bad block ratio is less than the 80% of the total lifetime of device, and the current size of the SLC buffer region 207 is less than the maximum reconfigurable size of the SLC buffer region 207. Hence, the flash memory meets the predefined criteria for SLC buffer reconfiguration and the system indicates feasibility of reconfiguring the current size of the SLC buffer region 207 by setting the flag value to “HIGH” for the field of feasibility of reconfiguring the current size of the SLC buffer region 207 of the register data 311.

Upon setting the flag value to the “HIGH” for the field of feasibility of reconfiguring the current size of the SLC buffer region 207, the buffer reconfiguration system 205 sets the field of maximum reconfigurable size of a SLC buffer region 207 to “HIGH” and activate the computation module 333 to compute the maximum reconfigurable size of a SLC buffer region 207.

The computation module 333 of the buffer reconfiguration system 205 computes a maximum reconfigurable size of a SLC buffer region 207 of the flash memory device 201. The maximum reconfigurable size of the SLC buffer region 207 is computed based on the one or more predefined parameters and remaining free blocks in a Multi-Level Cell (MLC) region in the flash memory device 201.

The maximum reconfigurable size of the SLC buffer region 207 is computed by using the following expression (and further modeled based on 40% of remaining free blocks):

$$= \frac{Remaining free blocks - Intermediate buffer sector}{Type of the MLC}$$

$$= \frac{23.6 - 5}{3} = \frac{18.6}{3} = 6.2 GB$$

For different percentages of remaining free blocks based on VPC of the 64 GB flash memory device 201, example maximum reconfigurable size of SLC buffer region 207 is given as follows:

| Sr. No. | Parameters | Quantity | | | | | | | |
|---|---|---|---|---|---|---|---|---|---|
| 1 | Total size of the TLC type NAND | 64 GB | | | | | | | |
| | based flash memory device. | | | | | | | | |
| 2 | Actual size of the TLC type NAND | ~59 GB | | | | | | | |
| | based flash memory device. | | | | | | | | |
| 3 | Remaining Free blocks based on | 100% | | 80% | | 60% | | 40% | |
| | VPC | | | | | | | | |
| 4 | Current size of the SLC buffer | 2 | GB | 2 | GB | 2 | GB | 2 | GB |
| | region | | | | | | | | |
| 5 | Erase Count (EC) | <70% | | <70% | | <70% | | <70% | |
| 6 | Bad block ratio | <80% | | <80% | | <80% | | <80% | |
| 7 | Maximum reconfigurable size of | 18 | GB | 14 | GB | 10.33 | GB | 6.2 | GB |

the SLC buffer region

From the above example, the buffer reconfiguration system 205 sends the response comprising an indication of the feasibility of reconfiguring the current size of the SLC buffer region 207 and the maximum reconfigurable size of the SLC buffer region 207 to the host 203 and sets the register's flag values for the field of the feasibility of reconfiguring the current size of the SLC buffer region 207 and the maximum reconfigurable size of the SLC buffer region 207 to “HIGH”.

Upon setting the register's flag values for the field of maximum reconfigurable size of the SLC buffer region 207 to “HIGH”, the host 203 may provide a command to reconfigure size of the SLC buffer region 207 from 2 GB to 5 GB. The buffer reconfiguration system 205 may set the register's flag value for the field of reconfigure the current size of the SLC buffer region 207 to “HIGH” and activate the allocation module 335 to reconfigure size of the SLC buffer region from 2 GB to 5 GB by allocating 3 GB of free blocks from the TLC region to the SLC buffer region 207. Therefore, the improved devices and methods overcome the deficiencies of the conventional devices and methods of memory device use, in particular, related to buffer region control, while reducing resource consumption (e.g., processing capability, power, bandwidth), improving performance (e.g., speed or operations, reliability of operations), and resource allocation (e.g., latency).

FIG. 4 shows a flowchart illustrating a method of dynamically reconfiguring size of a Single Level Cell (SLC) buffer region of a flash memory device 201, in accordance with some example embodiments of the present disclosure.

As illustrated in FIG. 4, the method 400 may include one or more blocks illustrating a method of dynamically reconfiguring size of a Single Level Cell (SLC) buffer region of a flash memory device 201 using the processor 303 configured in flash memory device 201 illustrated in FIG. 2 and FIG. 3A. The method 400 may be described in the general context of computer executable instructions. Generally, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, the method 400 includes receiving, by a processor 303 of a buffer reconfiguration system 205 associated with the flash memory device 201, a request from host 203 to determine a maximum reconfigurable size of a SLC buffer region 207 of the flash memory device 201.

At block 403, the method 400 includes determining, by the processor 303, a feasibility of reconfiguring a current size of the SLC buffer region 207 based on one or more predefined parameters related to the flash memory device 201, in response to the request received from the host 203. In some example embodiments, the one or more predefined parameters may include, but not limited to, a Valid Page Count (VPC) of the flash memory device 201, an Erase Count (EC) of the flash memory device 201, a bad block ratio of the flash memory device 201 and/or the current size of the SLC buffer region 207.

The determination of the feasibility of reconfiguring the current size of the SLC buffer region 207 comprises detecting, by the processor, a compliance of the one or more predefined parameters with a predefined criteria. In some example embodiments, the predefined criteria may include, but not limited to, VPC of the flash memory device 201 to be less than a first predefined threshold percentage, the current size of the SLC buffer region 207 to be less than the maximum reconfigurable size of the SLC buffer region 207, EC of the flash memory device 201 to be less than a second predefined threshold percentage of a total lifetime of the flash memory device 201, and/or a bad block ratio of the flash memory device 201 to be less than a third predefined threshold percentage of the total lifetime of the flash memory device 201. In some example embodiments, the predefined threshold percentage may be, alternatively, desired threshold percentage, determined threshold percentage, or selected threshold percentage.

At block 405, the method 400 includes computing, by the processor 303, the maximum reconfigurable size of the SLC buffer region 207 based on the one or more predefined parameters and remaining free blocks in a Multi-Level Cell (MLC) region 209 in the flash memory device 201, when the reconfiguration of the current size of the SLC buffer region 207 is determined to be feasible.

At block 407, the method 400 includes sending, by the processor 303, a response comprising an indication of the feasibility of reconfiguring the current size of the SLC buffer region 207 and the maximum reconfigurable size of the SLC buffer region 207 to the host 203.

At block 409, the method 400 includes receiving, from the host 203, by the processor 303, a command comprising an indication to reconfigure the current size to a new size of the SLC buffer region 207 determined based on the maximum reconfigurable size of the SLC buffer region 207. In some example embodiments, the new size of the SLC buffer region 207 is less than or equal to the maximum reconfigurable size of the SLC buffer region 207.

At block 411, the method 400 includes allocating, by the processor 303, a plurality of free blocks from the MLC region 209 to the SLC buffer region 207 to reconfigure the current size of the SLC buffer region 207 to the new size, in response to the command.

In some example embodiments, prior to allocating the plurality of free blocks to the SLC buffer region 207 to reconfigure the current size of the SLC buffer region 207 to the new size, the method comprises migrating pre-stored valid data from one or more blocks of the SLC buffer region 207 to one or more blocks of an MLC region 209 of the flash memory device 201, if there is a requirement (or alternatively, desire, command, or instruction) for migrating the pre-stored valid data.

In some example embodiments, prior to allocating the plurality of free blocks to the SLC buffer region 207 to reconfigure the current size of the SLC buffer region 207 to the new size, the method comprises sanitizing or purging pre-stored invalid data from one or more blocks of the SLC buffer region 207, when presence of invalid data is detected.

In some example embodiments, prior to allocating the plurality of free blocks to the SLC buffer region 207 to reconfigure the current size of the SLC buffer region 207 to the new size, the method comprises terminating one or more blocks of the SLC buffer region 207 which are in an operational condition.

The indication of the feasibility of reconfiguring the current size of the SLC buffer region 207, the maximum reconfigurable size of the SLC buffer region 207, and the reconfiguration of the current size of SLC buffer region 207 is performed using a new register comprising one or more fields. Said indication is performed by inserting values corresponding to the one or more fields.

### Computer System

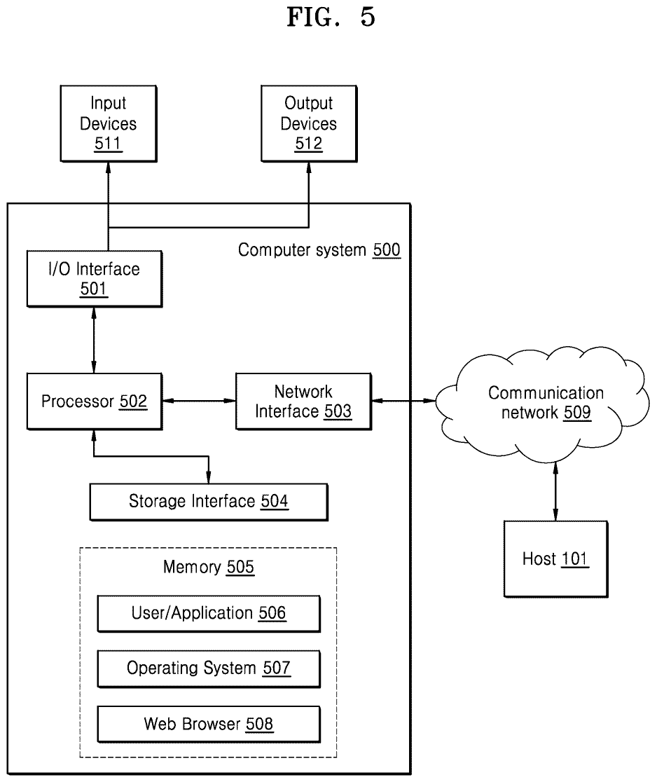

FIG. 5 illustrates a block diagram of an example computer system 500 for implementing embodiments consistent with the present disclosure. In some example embodiments, the computer system 500 may be buffer reconfiguration system 205 illustrated in FIG. 2. As an example, the NAND based storage device 201 may be a non-volatile storage device such as Solid-State Devices (SSDs), memory cards, Universal Flash Storage (UFS), an embedded Multi-Media Card (eMMC), a Non-Volatile Memory express (NVMe) based devices and the like. The computer system 500 may include a central processing unit (“CPU” or “processor” or “memory controller”) 502. The processor 502 may comprise at least one data processor for executing program components for executing user- or system-generated business processes. A user may include a network manager, an application developer, a programmer, an organization, or any system/sub-system being operated parallel to the computer system 500. The processor 502 may include specialized processing units such as integrated system (bus) controllers, memory controllers/memory management control units, floating point units, graphics processing units, digital signal processing units, etc.

The processor 502 may be disposed in communication with one or more Input/Output (I/O) devices (511 and 512) via I/O interface 501. The I/O interface 501 may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 501, the computer system 500 may communicate with one or more I/O devices 511 and 512.

In some example embodiments, the processor 502 may be disposed in communication with a network 107 via a network interface 503. The network interface 503 may communicate with the network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc.

In some example embodiments, the desired network 509 may be implemented as one of the several types of networks, such as intranet or Local Area Network (LAN) and such within the organization. The desired network 509 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP) etc., to communicate with each other. Further, the network 509 may include a variety of network devices, including routers, bridges, servers, computing devices, storage devices, etc. Using the network interface 503 and the network 509, the computer system 500 may communicate with a host 203.

In some example embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application interface 506, an operating system 507, a web browser 508, and the like. In some example embodiments, computer system 500 may store user/application data 506, such as the data, variables, records, etc. as described in this invention. Such databases may be implemented as fault-tolerant, relational, scalable, secure databases such as Oracle® or Sybase® or PostgreSQL®.

The operating system 507 may facilitate resource management and operation of the computer system 500. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

The user interface 506 may facilitate display, execution, interaction, manipulation, or operation of program components through textual or graphical facilities. For example, the user interface 506 may provide computer interaction interface elements on a display system operatively connected to the computer system 500, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Aero, Metro, etc.), web interface libraries (e.g., ActiveX®, JAVA®, JAVASCRIPT®, AJAX, HTML, ADOBE® FLASH®, etc.), or the like.

The web browser 508 may be a hypertext viewing application. Secure web browsing may be provided using Secure Hypertext Transport Protocol (HTTPS), Secure Sockets Layer (SSL), Transport Layer Security (TLS), and the like. The web browsers 508 may utilize facilities such as AJAX, DHTML, ADOBE® FLASH®, JAVASCRIPT®, JAVA®, Application Programming Interfaces (APIs), and the like. Further, the computer system 500 may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some example embodiments, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with some example embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of some example embodiments of the present disclosure are illustrated herein.

The present disclosure determines the feasibility of the reconfiguration of the SLC buffer region, computes the maximum reconfigurable size of the SLC buffer region and thereafter allocates a plurality of free blocks from the MLC region to the SLC buffer region. Therefore, the present disclosure provides the flexibility to the host to dynamically reconfigure the SLC buffer region of the flash memory device based on differing usage and relevant factors throughout the device's lifecycle.

The dynamic reconfiguration of the SLC buffer region 207 eliminates the need for repartitioning the flash memory device 201. Hence, the present disclosure prevents losing data stored in the flash memory device 201.

As stated above, it shall be noted that the method of the present disclosure may be used to overcome various technical problems related to NAND based memory devices. In other words, the disclosed method has a practical application and provides a technically advanced solution to the technical problems associated with the existing approach into non-volatile memory management.

In light of the technical advancements provided by the disclosed method, the claimed steps, as discussed above, are not routine, conventional, or well-known aspects in the art, as the claimed steps provide the aforesaid solutions to the technical problems existing in conventional technologies. Further, the claimed steps clearly bring improvements in the functioning of the system itself, as the claimed steps provide technical solutions to technical problems.

The terms “some example embodiments”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of some example embodiments with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, some other example embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, some example embodiments of the present invention are intended to be illustrative, but not limiting, of the scope of the invention, which is set forth in the following claims.

When the terms “about” or “substantially” are used in this specification in connection with a numerical value, it is intended that the associated numerical value includes a manufacturing or operational tolerance (e.g., +10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 200 | Architecture |
| 201 | Flash memory device |
| 203 | Host |
| 205 | Buffer reconfiguration system |
| 207 | Single Level Cell (SLC) buffer region |
| 209 | Multi-Level Cell (MLC) region |
| 301 | I/O Interface |
| 303 | Processor |
| 305 | Memory |
| 307 | Modules |
| 309 | Data |
| 311 | Register data |
| 313 | Page data |
| 315 | Block data |
| 317 | Parameters data |
| 319 | Reconfiguration criteria data |
| 321 | Other data |
| 331 | Determination module |
| 333 | Computation module |
| 335 | Allocation module |
| 337 | Operation module |
| 339 | Validation module |
| 341 | Other modules |
| 500 | Computer system |
| 501 | I/O Interface of the example computer system |
| 502 | Processor of the example computer system |
| 503 | Network interface |
| 504 | Storage interface |
| 505 | Memory of the example computer system |
| 506 | User/Application |
| 507 | Operating system |
| 508 | Web browser |
| 509 | Communication network |
| 511 | Input devices |
| 512 | Output devices |

We claim:

1. A method of dynamically reconfiguring size of a Single Level Cell (SLC) buffer region of a flash memory device, the method comprising:
receiving, by a buffer reconfiguration system associated with a flash memory device, a request from a host to determine a maximum reconfigurable size of a SLC buffer region of the flash memory device;
determining, by the buffer reconfiguration system, a feasibility of reconfiguring a current size of the SLC buffer region based on one or more parameters related to the flash memory device, in response to the request received from the host;
computing, by the buffer reconfiguration system, the maximum reconfigurable size of the SLC buffer region based on the one or more parameters and remaining free blocks in a Multi-Level Cell (MLC) region in the flash memory device, in response to the reconfiguration of the current size of the SLC buffer region being determined to be feasible;
sending, by the buffer reconfiguration system, a response comprising an indication of the feasibility of reconfiguring the current size of the SLC buffer region and the maximum reconfigurable size of the SLC buffer region to the host;
receiving, from the host, by the buffer reconfiguration system, a command comprising an indication to reconfigure the current size to a new size of the SLC buffer region determined based on the maximum reconfigurable size of the SLC buffer region; and
allocating, by the buffer reconfiguration system, a plurality of free blocks from the MLC region to the SLC buffer region to reconfigure the current size of the SLC buffer region to the new size, in response to the command.

2. The method as claimed in claim 1, wherein the one or more parameters comprises at least one of a Valid Page Count (VPC) of the flash memory device, an Erase Count (EC) of the flash memory device, a bad block ratio of the flash memory device or the current size of the SLC buffer region.

3. The method as claimed in claim 1, wherein determining the feasibility of reconfiguring the current size of the SLC buffer region comprises:
detecting compliance of the one or more parameters with at least one criteria, wherein the at least one criteria comprises:
VPC of the flash memory device to be less than a first threshold percentage;
the current size of the SLC buffer region to be less than the maximum reconfigurable size of the SLC buffer region;
erase count (EC) of the flash memory device to be less than a second threshold percentage of a total lifetime of the flash memory device; and
a bad block ratio of the flash memory device to be less than a third threshold percentage of the total lifetime of the flash memory device.

4. The method as claimed in claim 1, wherein the new size of the SLC buffer region is less than or equal to the maximum reconfigurable size of the SLC buffer region.

5. The method as claimed in claim 1, wherein prior to allocating the plurality of free blocks to the SLC buffer region to reconfigure the current size of the SLC buffer region to the new size, the method comprises migrating pre-stored valid data from one or more blocks of the SLC buffer region to one or more blocks of a Multi-Level Cell (MLC) region of the flash memory device, based on an instruction for migrating the pre-stored valid data.

6. The method as claimed in claim 1, wherein prior to allocating the plurality of free blocks to the SLC buffer region to reconfigure the current size of the SLC buffer region to the new size, the method comprises sanitizing or purging pre-stored invalid data from one or more blocks of the SLC buffer region, based on a presence of invalid data being detected.

7. The method as claimed in claim 1, wherein prior to allocating the plurality of free blocks to the SLC buffer region to reconfigure the current size of the SLC buffer region to the new size, the method comprises terminating one or more blocks of the SLC buffer region which are in an operational condition.

8. The method as claimed in claim 1, wherein
an indication of the feasibility of reconfiguring the current size of the SLC buffer region, the maximum reconfigurable size of the SLC buffer region, and the reconfiguration of the current size of SLC buffer region is performed using a new register comprising one or more fields, and
the indication is performed by inserting values corresponding to the one or more fields.

9. A buffer reconfiguration system for dynamically reconfiguring size of a Single Level Cell (SLC) buffer region of a flash memory device, the system comprising:
a processor; and
a memory, communicatively coupled to the processor, wherein the memory is configured to store instructions, which, on execution, causes the processor to:
receive a request from a host to determine a maximum reconfigurable size of a SLC buffer region of the flash memory device;
determine a feasibility of reconfiguring a current size of the SLC buffer region based on one or more parameters related to the flash memory device, in response to the request received from the host;
compute the maximum reconfigurable size of the SLC buffer region based on the one or more parameters and remaining free blocks in a Multi-Level Cell (MLC) region in the flash memory device, in response to the reconfiguration of the current size of the SLC buffer region being determined to be feasible;
send a response comprising an indication of the feasibility of reconfiguring the current size of the SLC buffer region and the maximum reconfigurable size of the SLC buffer region to the host;
receive, from the host, a command comprising an indication to reconfigure the current size to a new size of the SLC buffer region determined based on the maximum reconfigurable size of the SLC buffer region; and
allocate a plurality of free blocks from the MLC region to the SLC buffer region to reconfigure the current size of the SLC buffer region to the new size, in response to the command.

10. The system as claimed in claim 9, wherein the one or more parameters comprises a Valid Page Count (VPC) of the flash memory device, an Erase Count (EC) of the flash memory device, a bad block ratio of the flash memory device or the current size of the SLC buffer region.

11. The system as claimed in claim 9, wherein to determine the feasibility of reconfiguring
the current size of the SLC buffer region, the processor is configured to:
detect compliance of the one or more parameters with at least one criteria, wherein the at least one criteria comprises:
VPC of the flash memory device to be less than a first threshold percentage;
the current size of the SLC buffer region to be less than the maximum reconfigurable size of the SLC buffer region;
Erase Count (EC) of the flash memory device to be less than a second threshold percentage of a total lifetime of the flash memory device;
a bad block ratio of the flash memory device to be less than a third threshold percentage of the total lifetime of the flash memory device.

12. The system as claimed in claim 9, wherein the new size of the SLC buffer region is less than or equal to the maximum reconfigurable size of the SLC buffer region.

13. The system as claimed in claim 9, wherein prior to allocating the plurality of free blocks to the SLC buffer region to reconfigure the current size of the SLC buffer region to the new size, the processor is configured to migrate pre-stored valid data from one or more blocks of the SLC buffer region to one or more blocks of a Multi-Level Cell (MLC) region of the flash memory device, based on an instruction for migrating the pre-stored valid data.

14. The system as claimed in claim 9, wherein prior to allocating the plurality of free blocks to the SLC buffer region to reconfigure the current size of the SLC buffer region to the new size, the processor is configured to sanitize or purge pre-stored invalid data from one or more blocks of the SLC buffer region, based on a presence of invalid data being detected.

15. The system as claimed in claim 9, wherein prior to allocating the plurality of free blocks to the SLC buffer region to reconfigure the current size of the SLC buffer region to the new size, the processor is configured to terminate one or more blocks of the SLC buffer region in an operational condition.

16. The system as claimed in claim 9, wherein
the processor is configured to perform an indication of the feasibility of reconfiguring the current size of the SLC buffer region, the maximum reconfigurable size of the SLC buffer region, and the reconfiguration of the current size of SLC buffer region using a new register comprising one or more fields, and
the indication is performed by inserting values corresponding to the one or more fields.
